(19) United States
(12) Patent Application Publication
(10) Pub. No.: US 2002/0130152 A1
(43) Pub. Date: Sep. 19, 2002

(54) Optical fiber cleaver with traversing mechanism

(75) Inventor: Michael R. Cripps JR., Murfreesboro, TN (US)

Correspondence Address: BANNER & WITCOFF, 1001 G STREET N W, SUITE 1100, WASHINGTON, DC, 20001, US

(73) Assignee: Amherst Holding Co., Wilmington, DE

(21) Appl. No.: 10/023,693

(22) Filed: Dec. 21, 2001

Related U.S. Application Data
(60) Provisional application No. 60/276,488, filed on Mar. 19, 2001.

(51) Int. Cl. B26F 3/00

(52) U.S. Cl. 225/105; 225/93

(57) ABSTRACT

An optical fiber cleaver with a traversing mechanism and measuring device to impart relative movement between the cleaving blade and fiber holder and precisely control positioning of the blade along the axis of the fiber. In one embodiment, a cleaver blade is mounted on a translation stage which is movable relative to a stationary platform which supports the fiber holder. The cleaver blade mechanism is movable along the stage so as to precisely locate the blade for a cleaving operation. The cleaver is useful for producing stacks of different optical fibers fusion spliced together and ensuring that each fiber in the stack is precisely the correct length to maximize its characteristics. The measuring device or position indicator is coupled to the traversing mechanism and can be calibrated to a start position at the end of a first optical fiber. After a second optical fiber is fusion spliced to the first optical fiber, the cleaver can measure a precise length of the second fiber as predetermined for its characteristics. Subsequently additional optical fibers can be spliced to the end of the stack and cleaved to a precise length. The cleaver of the present invention enables for repeatability in producing stacked fibers and lends itself to automated production.

### FIELD OF THE INVENTION

The present invention is directed to an optical fiber cleaver with a traversing mechanism to facilitate accurate positioning cleaving blade relative to the fiber.

### BACKGROUND OF THE INVENTION

Optical fibers are normally constructed with a protective outer coating such as acrylate or another plastic material. The coating material is typically applied to the fiber during manufacture while the coating is still tacky. The coating may be subsequently cured by ultraviolet light to form the coated fiber. A jacket may be provided around one or more coated fibers for protection. Prior to splicing the optical fibers, the ends of two optical fibers to be spliced together need to be stripped of their protective coating and cleaved to provide an accurately sheared end surface for mating.

Preparation of the fibers by stripping the coating can be accomplished with use of an optical fiber preparation unit as disclosed in commonly assigned U.S. Pat. No. 5,946,986, the disclosure of which is hereby incorporated by reference.

To prepare optical fibers for splicing, a device known as a cleaver is used to induce a flaw in the surface of the optical fiber and apply a force to cause the fiber to fracture along a plane perpendicular to its main axis. Typically the fiber is scribed along its circumference and then a force such as a tensile force or a bending moment is imparted to the fiber to cause the desired fracture. The most advantageous type of fracture is one in which the fracture occurs at substantially a 90° angle relative to the longitudinal axis of the fiber to expose a sheared end surface that is a perpendicular plane relative the axis.

In the creation of certain optical devices, it is desirable to create a “stack” of various types of optical fiber. This may be done to create a lens to project or capture light at the end of a fiber or to modify the propagation of light along a fiber. A stack may comprise one or more short segments of fiber which are spliced at the end or middle of a longer fiber. Each segment may consist of a different type of fiber, with different characteristics. The segments are typically spliced together by fusion splicing. A typical example of a stacked fiber 10 is shown in FIG. 5 in which an input fiber 12 and an output fiber 14 have spliced in between their ends, a stack 16 of three different fiber types 18a, 18b and 18c.

To produce the desired optical effect, it is necessary that the length of each segment of the stack be closely controlled. The required length of a segment may be 1 μm to 1000 μm, or more, in length, with a required accuracy generally in the range of +/−0.5 μm. With conventional tools it is not practical to prepare very short lengths of fiber and then splice them to the stack. The accepted method is to splice a reasonable length, 50 mm or more, of each segment fiber to the end of the existing fiber, and then to cleave the added fiber to the correct length before adding on the next segment.

A microscope with appropriate optics can discern the boundary line between the fibers of the stack. Therefore it is possible to determine by examination the point at which the fiber should be cleaved to length. However, with existing cleavers, there is no provision for accurately positioning the cleaving blade's position along the axis of the fiber. The user must often make multiple attempts to manually position the fiber within the cleaving mechanism so as to bring the correct point on the fiber within the path of the blade. This method is difficult and time-consuming and requires a high degree of skill. Also, because a much longer length of fiber than necessary is spliced onto the stack and then cleaved, this method also results in a considerable amount of waste. This conventional method of making “stacks” of optical fibers is unsatisfactory, especially for high volume production of fiber stacks.

There is a need for a reliable, repeatable and accurate way of forming optical fiber stacks to enable volume production and reduce waste. Specifically, there is a need for an apparatus that enables precise positioning of a cleaving blade relative to the length of the fiber segment.

### BRIEF SUMMARY OF THE INVENTION

The optical fiber cleaver of the present invention addresses the drawbacks of the prior art by providing for relative motion of the cleaving blade to the fiber holder in a measured manner to provide a precise cleaving location and repeatability. In one embodiment, the cleaver includes a platform or bearing affixed to a stationary frame or housing for supporting a magnetic fiber holder, and a translation stage mounted on the frame with a cleaving blade mechanism mounted movably thereon. The cleaving blade is coupled to a fine resolution adjustment mechanism and a measuring device to indicate the exact position of the blade with respect to a starting point. The cleaving operation is carried out on a fiber that is retained in the holder and clamped and tensioned in the cleaver. The cleaver of the present invention greatly improves the process of making optical fiber stacks. The measuring device and adjustment mechanism ensure repeatability of the process to enable volume production of optical fiber stacks.

In another embodiment, the relative positioning is accomplished by mounting the fiber holder on a translation stage and keeping the cleaving blade mechanism stationary.

An aspect of the invention is to provide relative motion between the cleaving blade and the fiber holder, and thus the clamped fiber itself.

Another aspect of the invention is to provide a reliable and repeatable apparatus and method for producing optical fiber stacks.

### BRIEF DESCRIPTION OF THE DRAWINGS

FIG. 1 is a top perspective view of an optical fiber cleaver in accordance with the present invention.

FIG. 2 is a schematic view of the components of the cleaver of FIG. 1

FIG. 3 is a detailed schematic view of the cleaving blade assembly of the cleaver of FIG. 1.

FIG. 4 is a top plan view of one side of a fiber holding component of the cleaver of FIG. 1 shown with its pivotal clamping element in an open position.

FIG. 5 is a schematic diagram of a stack of optical fibers spliced together in longitudinal alignment.

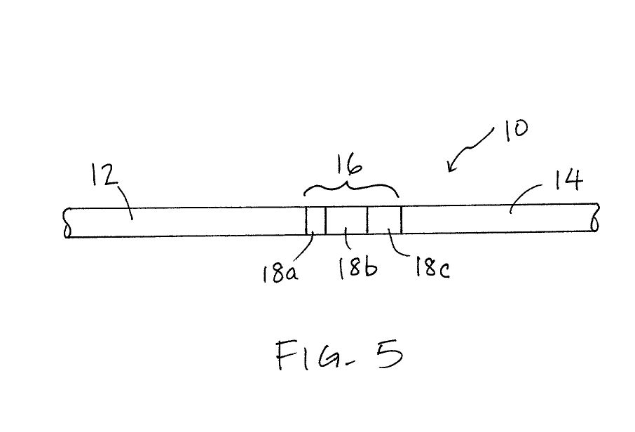

### DETAILED DESCRIPTION OF THE INVENTION

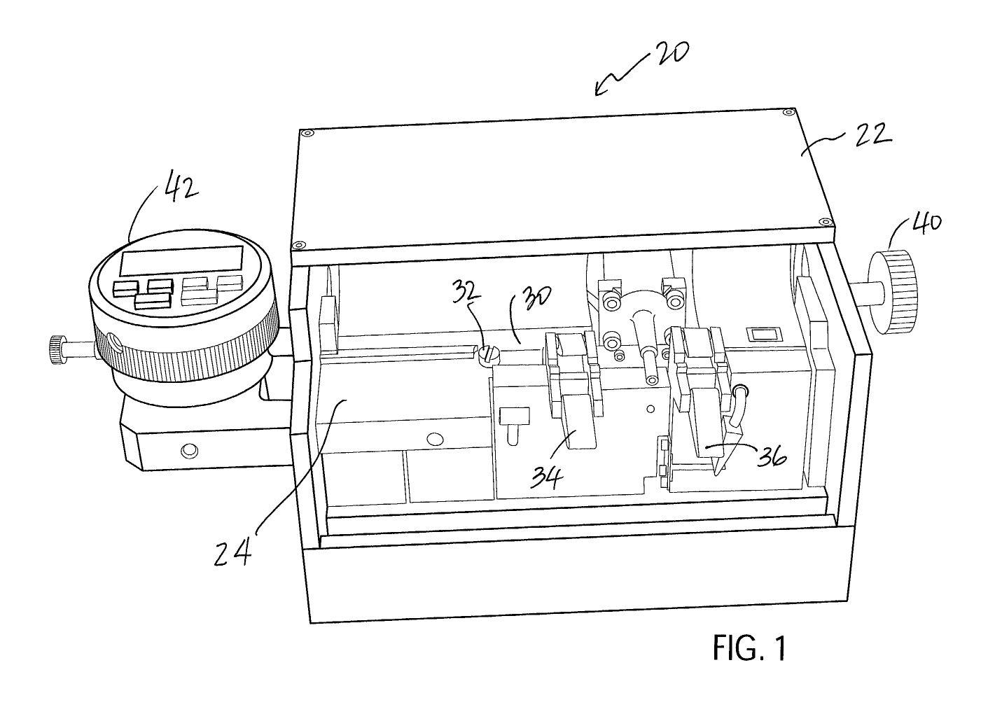

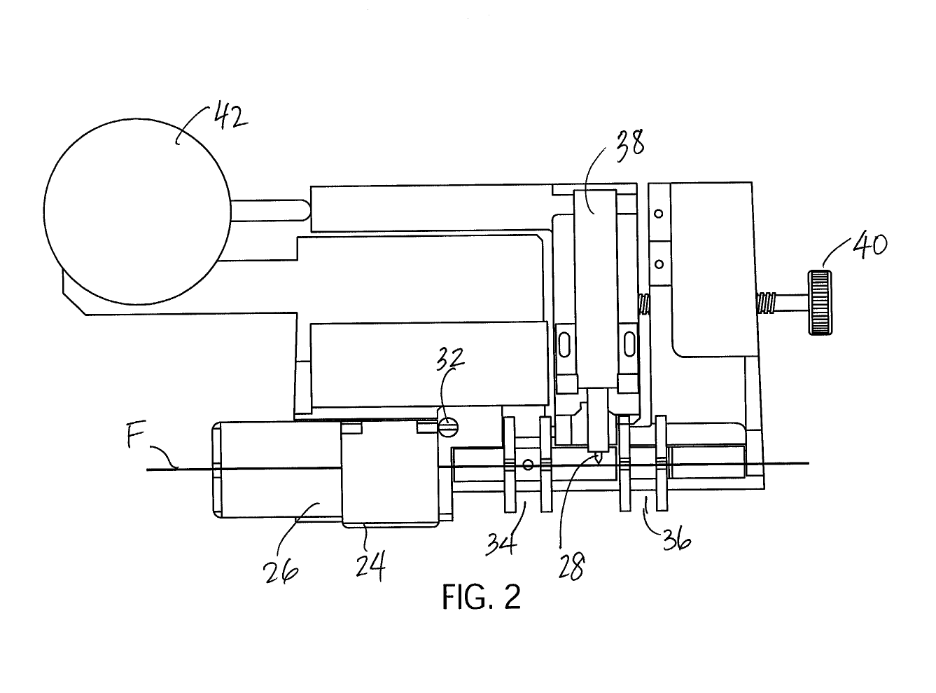

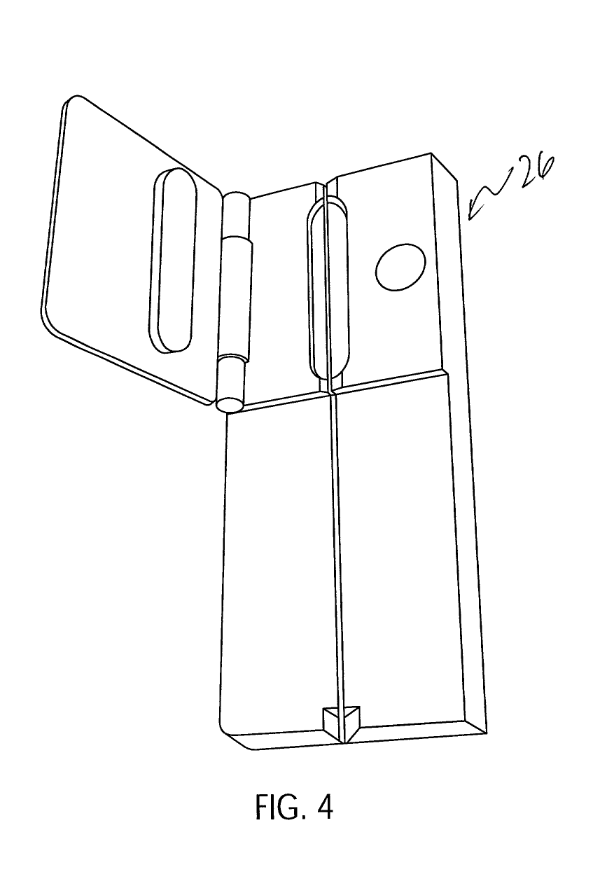

In order to overcome the disadvantages of conventional cleaver, cleaver 20 of the present invention includes an adjustable traversing mechanism incorporated into the apparatus to provide relative positioning of the cleaving blade and the fiber optic clamping mechanism, and high resolution measuring mechanism to provide a visual indication of the distance that the traversing mechanism has moved. As seen in FIGS. 1-2, cleaver 20 comprises a frame or housing 22 that contains a platform 24 for supporting a fiber optic clamping mechanism or fiber holder 26, and a cleaving blade 28 mounted on a slide 30. Magnetic fiber holder 26, FIG. 4, is detachably supported on a fiber holder platform 24 mounted to a fixed part of the housing. Course adjustment screw 32 enables a limited degree of coarse positioning of the fiber holder relative to the cleaving blade and is used on conventional cleavers. The course adjustment screw is generally used as a “set and forget” adjustment so that for purposes of cleaving fibers and measuring in accordance with the present invention, the fiber holder platform is fixed relative to the housing.

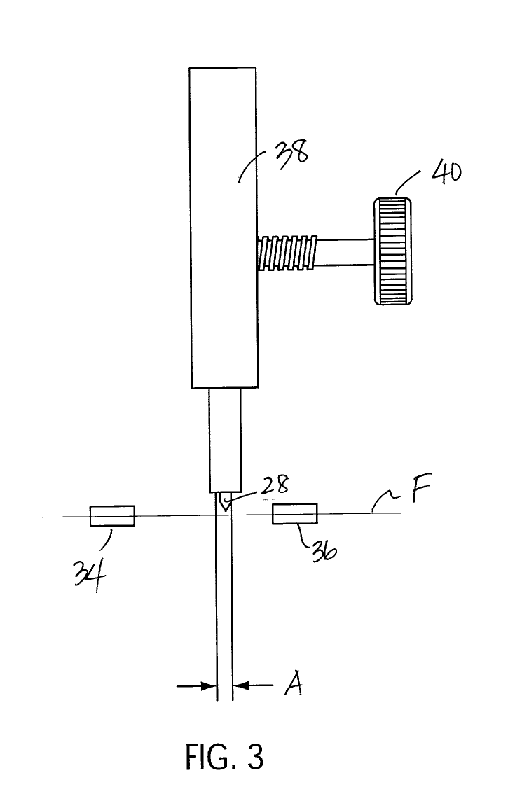

Downstream of fiber holder 26 is a fiber clamp 34 which is disposed between the fiber exit end of the fiber holder and cleaving blade 28. On the other side of cleaving blade 28 is a fiber tensioning clamp 36, FIG. 3. An optical fiber F is held in fiber holder so that an end of fiber F extends out of the holder, in fiber clamp 34, proximate cleaving blade 28 and in fiber tensioning clamp 36. Clamps 34 and 36 are designed to clamp the fiber without causing damage and maintain the fiber's position proximate cleaving blade 28.

In the illustrated embodiment cleaving blade 28 is coupled to a blade housing 38 which contains the driving mechanism to impart ultrasonic vibration to the blade to score the fiber. A blade mechanism as described in U.S. Pat. No. 4,790,465 (which is hereby incorporated by reference) can be used in the cleaver of the present invention. The blade housing is moveably mounted on slide 30. The position of the blade housing, and therefore the blade, along the slide is controlled by a fine-pitch screw 40. The adjustment area A is illustrated schematically in FIG. 3. The slide or traversing mechanism is a translation stage such as the commercially available Newport Ultra-Compact Ball Slide Positioner Stage, Model 450A. The translation stage is coupled to a position indicator 42 which is mounted in an easily viewed area. As seen in FIG. 2 the position indicator can be mounted on the exterior of the housing, but depending on the cleaver configuration, could be mounted within the housing.

The position indicator provides visual indication of the distance that the blade has moved relative to a calibrated zero position. The indicator can be of any appropriate type such as a dial gauge or digital display. An example of such a measuring device is a Starret Wisdom Plus Series Electronic Indicator, Model F2710-0. An indicator enables fine adjustment of the length of the fiber, and importantly, repeatability of the cleaving operation with other fibers. The high resolution adjustability and the feedback provided by the position indicator enables high volume production of optical fiber stacks.

Cleaver operation can be automated by use of a stepper motor to perform the adjustment motion of the blade housing along the translation stage in place of the fine pitch screw. Once a desired position for cleaving is determined, that location can be repeated reached by the stepper motor by any method such as counting drive pulses.

This enables the cleaver to be coupled to a processor that can carry out the cleaving operation automatically.

To operate cleaver 20, the blade position is set to a beginning position, and the measuring mechanism or indicator 42 is observed to determine the starting indication. The indicator 42 is thus calibrated to “zero” at the start position. A first fiber is then placed in fiber holder 26, stripped and cleaned by any suitable techniques and then the fiber holder is placed into cleaver 20 on platform 32. The fiber is held in fiber clamp 34 and in fiber tensioning clamp 36 proximate cleaving blade 28. Cleaving blade 28 is employed to cleave the first fiber so that the end of the first fiber corresponds to “zero” on the indicator. Fiber holder 26 is then removed from cleaver 20 in order to fusion splice the first fiber to a second fiber. Fiber holder 26, which now holds the spliced fibers, is placed back into cleaver 20. The traversing mechanism is actuated to move cleaving blade 28 distally along the fiber axis a desired distance as indicated by measuring device 42. The cleaving blade is operated to cleave the second fiber at the desired length. The process from the splicing step can be repeated as many times as necessary to create the desired fiber stack.

The length of the stacked fiber can be controlled precisely. The third and subsequent fibers may all be cleaved to different lengths. Since the length of each fiber is indicated on the measuring device 42 and controlled by actuation of blade housing 38 on slide 30, the production of a stack of fibers can easily be repeated. The process can be further enhanced with a stepper motor driving the blade housing along the slide to automate production.

Although the illustrated embodiment shows the blade housing coupled to the traversing mechanism, the same results can be attained by configuring the cleaver so that the blade housing is fixed and the fiber holder coupled to a traversing mechanism. A traversing mechanism for the fiber holder would operate under the same principles and with similar components: a translation stage, a position indicator and controller. Precise relative positioning of the cleaving blade to a cleaving position whether accomplished by moving the blade or moving the fiber is contemplated to be within the purview of the present invention.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. An apparatus for cleaving optical fibers comprising:
a frame;
a platform affixed to said frame for supporting a detachable fiber holder;
a traversing mechanism affixed to said frame, said traversing mechanism carrying a cleaving blade movably therealong; and
a position indicator coupled to said traversing mechanism for indicating the position of the cleaving blade.

2. The apparatus of claim 1, further comprising a clamp proximate said platform for clamping an optical fiber.

3. The apparatus of claim 2, further comprising a tensioning clamp aligned with said clamp for clamping and tensioning an optical fiber.

4. The apparatus of claim 3, wherein said cleaving blade is movable between said clamp and said tensioning clamp.

5. The apparatus of claim 1, wherein said traversing mechanism comprises a translation stage and cleaving blade mechanism mounted slidingly thereon.

6. An optical fiber cleaver comprising:
a frame;
a cleaving blade mechanism;
a bearing for engaging a detachable fiber holder;
a measuring device;
wherein one of said blade mechanism or said bearing is movably mounted on said frame and coupled to said measuring device to enable precise positioning of said blade mechanism relative to said bearing.

7. The cleaver of claim 6, wherein said measuring device includes a visual display.

8. The cleaver of claim 6, further comprising a clamp for clamping an optical fiber.

9. The cleaver of claim 8, further comprising a tensioning clamp aligned with said clamp for clamping and tensioning an optical fiber.

10. The cleaver of claim 6, further comprising a translation stage onto which said cleaving blade mechanism is mounted slidingly thereon.

11. An apparatus for cleaving optical fibers comprising:
a frame;
an bearing affixed to said frame for engaging a detachable fiber holder;
a cleaving blade disposed proximate said bearing; and
means for moving said blade and said bearing relative to one another along a longitudinal axis.

12. The apparatus of claim 11, further comprising a position indicator coupled to said traversing mechanism for indicating the position of the cleaving blade.

13. The apparatus of claim 11, further comprising a clamp proximate said bearing for clamping an optical fiber.

14. The apparatus of claim 13, further comprising a tensioning clamp aligned with said clamp for clamping and tensioning an optical fiber.

15. The apparatus of claim 11, wherein said cleaving blade is movable between said clamp and said tensioning clamp.

16. The apparatus of claim 11, wherein said traversing mechanism comprises a translation stage and said cleaving blade is mounted slidingly thereon.

17. The apparatus of claim 11, wherein said bearing is a platform for supporting a magnetic fiber holder.

18. The apparatus of claim 11, wherein said frame is enclosed in a housing.
